(19) United States
(12) Patent Application Publication
(10) Pub. No.: US 2026/0101838 A1
(43) Pub. Date: Apr. 16, 2026

(54) Device for removing garlic inflorescences.

(71) Applicants: Kateryna Suprun Henzler, Hilton Head Island, SC (US); Yurii Suprun, Zaporizhzhia (UA)

(72) Inventors: Kateryna Suprun Henzler, Hilton Head Island, SC (US); Yurii Suprun, Zaporizhzhia (UA)

(21) Appl. No.: 19/198,613

(22) Filed: May 5, 2025

(51) Int. Cl. A01D 23/02

(52) U.S. Cl. CPC A01D 23/02; A01D 2023/022

(57) ABSTRACT

The invention relates to the agriculture, specifically to the garlic growing. When the inflorescence of the garlic forms a loop, equipment is used. A device for removing garlic inflorescences comprise a frame made of a profile pipe, on which the elements of the tractor hitch and two pneumatic wheels are firmly attached, as well as the shaft of the equipment, fixed to be able to rotate on two bearings. Moreover, there is a drive installed on one side of the shaft-a hydraulic motor, with the possibility of setting it into rotation by oil pumped by the tractor's hydraulic system, as well as a flow regulator. The base of the invention is reducing the time of the process and its automatization.

### RELATED APPLICATION

This application is based on the provisional patent application No. 63/561,893, filed on Mar. 6, 2024, confirmation No. 9626.

### RELATED ART

As winter bolting garlic grows, seed inflorescences form on the plant, which must be removed when growing garlic commercially. When the inflorescence forms a loop, equipment must be used.

### BACKGROUND OF INVENTION

Currently, this process is done manually using a hand tool, which is inconvenient, labor-intensive, and requires labor. Thus, this invention has no analogues.

The equipment is designed to mechanize the process of removing garlic inflorescences to minimize manual labor and careful handling of the plant.

Device for removing garlic inflorescences is attached to a tractor, the tractor's hydraulic system rotates the drive shaft with polyurethane rotors, pre-adjusted to a certain angle of grip, depending on the conditions of use.

The tractor starts moving at a speed of 10 km/h. The rotors hit the loop and the stalk gets damaged, which prevents further development of the inflorescence and leads to a significant increase in the crop of commercial garlic.

### SUMMARY OF INVENTION

The bases of the invention is reducing the time of the process and its automatization.

The task is solved due to the fact that the device for removing garlic inflorescences according to the invention, contains a frame made of a profile pipe, on which the elements of the tractor hitch and two pneumatic wheels are stationery fixed, as well as the shaft of the equipment, fixed with the possibility of rotation on two bearings, and there's drive on one side of the shaft is installed, called a hydraulic motor with the possibility of setting it in rotation by pumping oil by the tractor's hydraulic system, as well as a flow regulator.

According to one embodiment of the invention, adjustable brackets are installed on the shaft every 100 mm.

According to another embodiment of the invention, the rotor is made of polyurethane with a hardness of 45-60 units according to Shore A and has a certain color, where Yellow is 45 shore A, Red is 60 shore A.

In accordance with another embodiment, the number of beams is at least 7, curved against the direction of rotation, and inside each beam in the working area there is a thinning.

According to another version, there is a hole inside the rotor, made with the possibility of rotating the rotor by 15 degrees relative to the axis of rotation and 6 holes with a diameter of 9 mm with the possibility of fastening to a rotary bracket.

According to another embodiment of the invention, the device includes an input connector designed to allow hydraulic oil from the tractor to flow through it to the flow regulator and hydraulic motor, as well as an output connector designed to drain oil through it.

### BRIEF DESCRIPTION OF THE DRAWINGS

FIG. 1 shows the general appearance of the device; FIG. 2 shows the process of adjusting the angle of grip by the polyurethane rotor; FIG. 3 shows the polyurethane rotor; FIG. 4 shows the principle of removing the replaceable inflorescence;

### DETAILED DESCRIPTION OF THE INVENTION

The shaft (10) is mounted on a frame made from profile pipes. The hydraulic system of the tractor rotates the hydraulic motor (12), which transmits rotation to the shaft with installed working bodies—rotors (9).

The working bodies—rotors (9) are made of soft polyurethane and have individual aggressiveness adjustment.

The process of removing inflorescences should be started when the garlic plant enters the initial flowering phase. The operator selects the number of shaft revolutions, the inclination of the rotor relative to the rotation axis, and the height above the ground. The working element-the rotor, when rotating at a frequency from 100 to 300 revolutions per minute, strikes the stalk of the garlic inflorescence with a blade. This leads to damage to the stalk, as a result of which its unwanted growth stops.

Leaves with a more elastic structure slip between the working bodies. And remain whole and undamaged.

The equipment is equipped with a standard hitch for attachment to a tractor, hydraulic oil flow regulator (1), pneumatic wheels (2), mechanism for adjusting the height above the ground level (6). The working bodies are installed at a distance of 100 mm between each other and have an individual adjustment of the angle of inclination relative to the axis of rotation. This ensures the optimal working width of capture of garlic inflorescences. The speed of the tractor is up to 10 kmh.

The equipment has very high performance indicators and minimal damage to plants.

### Device

There are the elements of the tractor hitch (4) and two pneumatic wheels (2) attached on the beam (1) made of profile pipe. The equipment shaft (10) is attached on two bearings (7,11) there is a drive on one side-a hydraulic motor (12) driven into rotation by oil pumped by the tractor's hydraulic system. The motor speed is regulated by the flow regulator (1). Adjustable brackets (8) are installed on the shaft every 100 mm, allowing the rotor tilt angle to be adjusted relative to the rotation axis, on which polyurethane rotors (9) are installed. The equipment provides the adjustment of the machine depending on the height of the plants (6).

The entire oil system is connected by high-pressure hoses, at the end of which the joining connectors (5) are installed to the tractor's oil system.

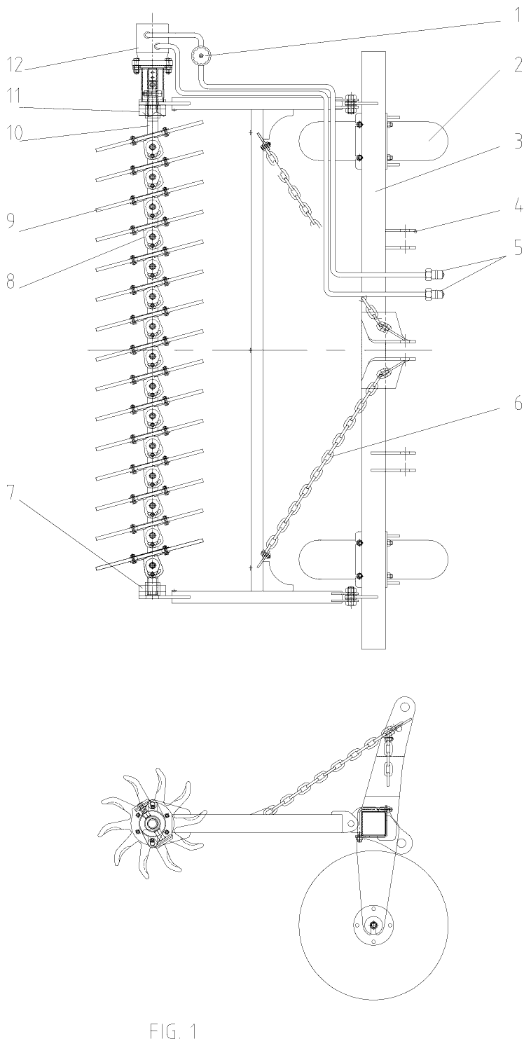

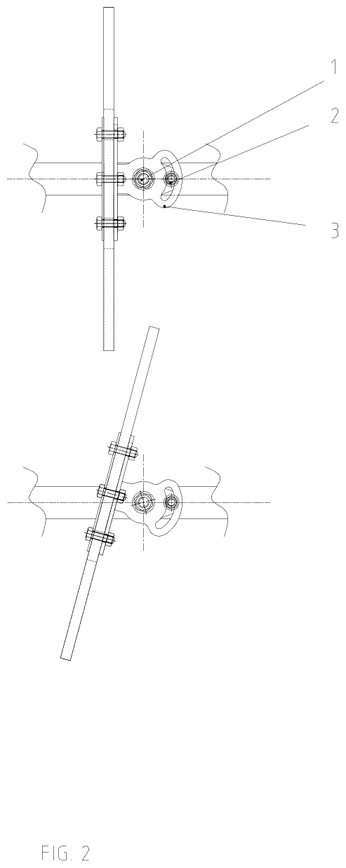

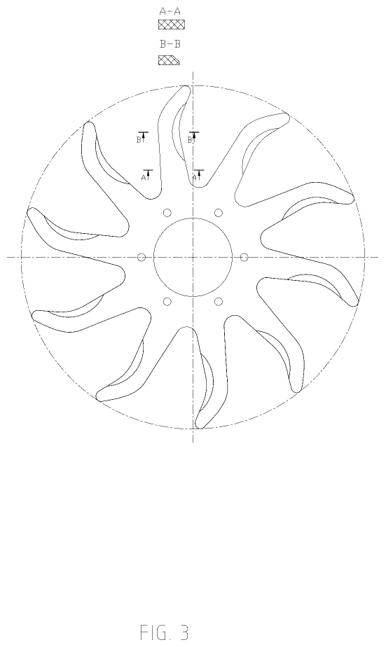

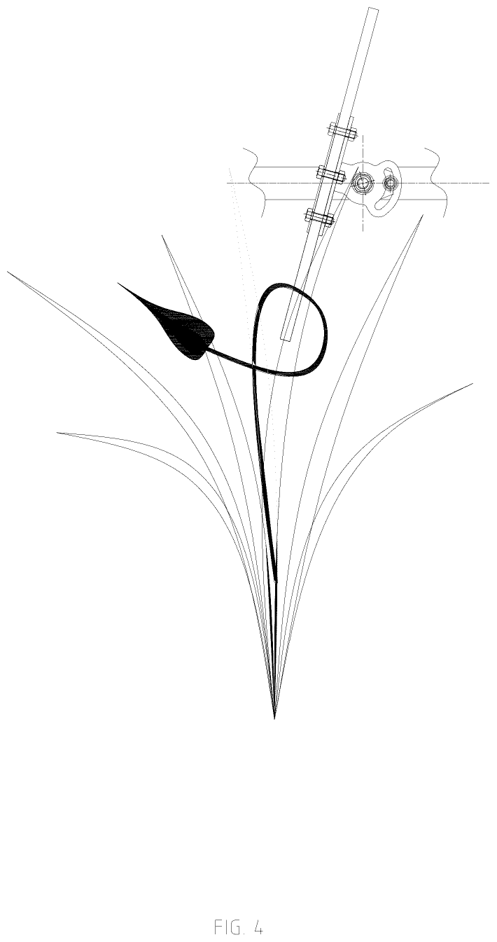

As winter bolting garlic grows, seed inflorescences are formed on the plant, which must be removed when growing garlic commercially (FIG. 1). When the inflorescence forms a loop, it is necessary to use the proposed equipment.

The device for removing garlic inflorescences is connected to the tractor, to the tractor's hydraulic system through connectors (5), the flow of oil pumped by the tractor passes through the regulator and rotates the shaft (10) with the rotary brackets (8) installed on it with polyurethane rotors (9) attached to them.

The angle of attack of polyurethane rotors (9) can be changed by turning bracket (8) to achieve the best processing result, also the efficiency of work can be changed by changing the length of chain (6) shortening or lengthening it depending on the level of seed inflorescences above the soil surface. The tractor starts moving at a speed of 10 km/h.

The rotors hit the loop of the seed inflorescence and it gets damaged, which prevents further development of the inflorescence and leads to a significant increase in the crops of commercial garlic.

To improve the productivity and quality of the equipment, the rotor hitting angle is adjustable (see FIG. 2). You need to loosen the screw (1) and bolt (2), turn bracket (3) with the rotor to the required angle of rotation from 0 to 15 degrees and tighten it.

The polyurethane rotor is a ten-pointed star with curved beams (see FIG. 3). Each beam has a variable cross-section along the length due to the operating principle. The rotors have holes for attaching them to a rotating bracket to change the angle of hitting, which improves the quality of work and increases productivity.

Polyurethane rotors are used in different degrees of hardness from 45 shore A to 60 shore A for certain types of work. Polyurethane rotors are painted in different colors depending on the hardness: yellow is the softest, green is medium, red is the hardest.

The polyurethane rotor rotates at 150- 300 rpm and strikes the seed inflorescence, damaging it, thereby stopping its growth (see FIG. 4).

The rotor (9) is made of polyurethane with a hardness of 45-60 shore A according. It has a certain color. Yellow is 45 shore A, Red is 60 shore A. It has at least 7 identical beams curved against the direction of rotation. Inside each beam in the working area there is a thinning.

Inside the rotor there is a hole allowing the rotor to be rotated 15 degrees relative to the axis of rotation and 6 holes with a diameter of 9 mm for mounting to a swivel bracket.

The hydraulic system is designed as follows. Hydraulic oil from the tractor is supplied through the input connector (5) to the flow regulator (1) and the hydraulic motor (12), and the oil is drained through the output connector (5).

### CLAIMS OF THE INVENTION

1. A device for removing garlic inflorescences comprising a frame made of a profile pipe, on which the elements of the tractor hitch and two pneumatic wheels are fixedly attached, as well as the shaft of the equipment, fixed so as to be able to rotate on two bearings, moreover, on one side of the shaft a drive is installed-a hydraulic motor, with the possibility of setting it into rotation by oil pumped by the tractor's hydraulic system, as well as a flow regulator.
2. The garlic inflorescence removal device according to Clause 1, characterized in that the shaft has adjustable brackets for changing the angle of grip to adjust the efficiency of the garlic inflorescence removal process.
3. The polyurethane rotor is a multibeam structure curved against the direction of rotation made of polyurethane of different stiffness from 45 to 60 Sh A units, with holes for fastening and a central hole for rotation on the axis of rotation, considering the fact that the beam of the polyurethane rotor has a variable cross-section from the center to the edge.

1. A device for removing garlic inflorescences comprising a frame made of a profile pipe, on which the elements of the tractor hitch and two pneumatic wheels are fixedly attached, as well as the shaft of the equipment, fixed so as to be able to rotate on two bearings, moreover, on one side of the shaft a drive is installed-a hydraulic motor, with the possibility of setting it into rotation by oil pumped by the tractor's hydraulic system, as well as a flow regulator.

2. The garlic inflorescence removal device according to Clause 1, characterized in that the shaft has adjustable brackets for changing the angle of grip to adjust the efficiency of the garlic inflorescence removal process.

3. The polyurethane rotor is a multibeam structure curved against the direction of rotation made of polyurethane of different stiffness from 45 to 60 Sh A units, with holes for fastening and a central hole for rotation on the axis of rotation, considering the fact that the beam of the polyurethane rotor has a variable cross-section from the center to the edge.
